(19) United States
(12) Patent Application Publication
(10) Pub. No.: US 2026/0342628 A1
(43) Pub. Date: Oct. 29, 2026

(54) RADIO APPARATUS FOR 8PSK DEMODULATION

(71) Applicant: Nordic Semiconductor ASA, Trondheim (NO)

(72) Inventor: Li Wei, Trondheim (NO)

(73) Assignee: Nordic Semiconductor ASA, Trondheim (NO)

(21) Appl. No.: 19/655,444

(22) Filed: Apr. 22, 2026

(30) Foreign Application Priority Data
Apr. 23, 2025 (GB) 2506069.0

(51) Int. Cl. H04L 27/20; H04L 27/22

(52) U.S. Cl. CPC H04L 27/20; H04L 27/22

(57) ABSTRACT

A radio apparatus configured to demodulate an eight-phase-shift-key-modulated (8PSK) radio-frequency (RF) signal. The radio apparatus includes a quadrature demodulator and a soft demodulator. The quadrature demodulator is configured to determine, for a symbol of the RF signal, a first position <x, y> on a constellation diagram. The soft demodulator is configured to: apply a rotation to the first position <x, y> to determine a second position <x′, y′> on the constellation diagram; determine an absolute value of x′ or y′; and determine a soft demodulation of the symbol. Determining the soft demodulation comprises setting an absolute value of a soft bit equal to the absolute value of x′ or y′.

### CROSS REFERENCE TO RELATED APPLICATION

This application claims priority from United Kingdom Patent Application No. 2506069.0, filed Apr. 23, 2025, which application is incorporated herein by reference in its entirety.

### TECHNICAL FIELD

This disclosure relates to apparatus and methods for demodulating eight-phase-shift-key-modulated radio-frequency signals.

### BACKGROUND

Radio transmission systems are used to transmit signals from a transmitter apparatus to a receiver apparatus. In some systems, digital message data is modulated onto one or more phase-modulated carriers using phase-shift keying (PSK). Examples include Bluetooth™ and Bluetooth Low Energy (BLE)™.

Eight-phase-shift keying (8PSK) is a coherent modulation technique that sets the phase of a carrier to one of eight phases in each symbol period, each phase being representative of a different three-bit symbol. A digital message can be communicated as a succession of such symbols.

A radio apparatus may be required to demodulate received 8PSK-modulated radio-frequency signals before decoding the digital message. Rather than decoding directly to hard bit values (i.e. zero or one), some demodulation methods first demodulate each symbol as three soft-decision bits (e.g. each being a real value between −1 and 1), and then decode these soft bits into hard bit values. Where convolution encoding is used in the message transmission, the soft bits may, for example, be provided as input to a Viterbi decoder.

It can be desirable to demodulate an 8PSK radio-frequency signal into soft bits using an approach that is power efficient and/or computationally efficient.

### SUMMARY

From a first aspect, the present disclosure provides a radio apparatus configured to demodulate an eight-phase-shift-key-modulated radio-frequency signal, wherein the radio apparatus comprises:
an interface, configured to receive an eight-phase-shift-key-modulated radio-frequency signal;
a quadrature demodulator, configured to quadrature demodulate the radio-frequency signal to determine, for a symbol of the radio-frequency signal, a first position <x, y> on a predetermined constellation diagram, wherein the predetermined constellation diagram comprises an X-axis, a Y-axis, and eight constellation points; and
a soft demodulator, configured to:
   apply a first rotation to the first position <x, y> about an origin of the constellation diagram to determine a second position <x′, y′> on the constellation diagram, wherein the second position <x′, y′> is rotated relative to the X-axis and the Y-axis;
   determine an absolute value of x′ or y′; and
   determine a soft demodulation of the symbol, wherein the soft demodulation comprises three soft bits, and wherein the determining of the soft demodulation comprises using the determined absolute value of x′ or y′ to set an absolute value of one of the three soft bits equal to the absolute value of x′ or y′.

From a second aspect, the present disclosure provides a method of demodulating an eight-phase-shift-key-modulated radio-frequency signal, the method comprising:
receiving an eight-phase-shift-key-modulated radio-frequency signal;
quadrature demodulating the radio-frequency signal to determine, for a symbol of the radio-frequency signal, a first position <x, y> on a predetermined constellation diagram, wherein the predetermined constellation diagram comprises an X-axis, a Y-axis, and eight constellation points;
applying a first rotation to the first position <x, y> about an origin of the constellation diagram to determine a second position <x′, y′> on the constellation diagram, wherein the second position <x′, y′> is rotated relative to the X-axis and the Y-axis;
determining an absolute value of x′ or y′; and
determining a soft demodulation of the symbol, wherein the soft demodulation comprises three soft bits, and wherein determining the soft demodulation comprises using the determined absolute value of x′ or y′ to set an absolute value of one of the three soft bits equal to the absolute value of x′ or y′.

Thus it will be seen that, in accordance with embodiments of the present disclosure, an efficient demodulation can be achieved by applying a first rotation to the first position <x, y> and using the absolute value of one of the X, Y coordinates of the second position <x′, y′> as the absolute value of one of the three-bits of the soft demodulation of the symbol. As explained in more detail below, examples of this approach have been found to be more computationally efficient than other demodulation methods, while still providing sufficiently accurate demodulation performance. Each soft bit may represent or approximate a respective likelihood value (e.g. the logarithm of probability of a particular value) for a respective bit of the modulated symbol.

When a symbol is demodulated as described herein, the absolute value of the one of the three soft bits may be determined without searching for a nearest constellation point (e.g. the nearest of the constellation points or rotated constellation points) to either, or both, of the first position <x, y> and the second position <x′, y′>. This can help to provide an efficient approach for determining the absolute value of the one of the three soft bits.

In some embodiments, the absolute value of the one of the three soft bits is determined without determining a distance between any constellation points (e.g. any of the constellation points or rotated constellation points) and either, or both, of the first position <x, y> and the second position <x′, y′>. This can help to provide a particularly efficient approach for soft demodulation of the received symbol.

In some embodiments, the interface may be an electrical interface configured to be coupled, directly or indirectly, to an antenna. The antenna may be configured to receive a radio signal from the radio-frequency (RF) signal may be derived. The antenna may be part of the radio apparatus or may be separate from the radio apparatus. In some embodiments, the interface may be an antenna, and the radio apparatus may be configured to receive the RF signal as a radio signal.

In some embodiments, the soft demodulator is configured to output the soft demodulation of the symbol. For instance, the soft demodulator may be configured to output the soft demodulation of the symbol to a decoder (e.g. a Viterbi decoder). The radio apparatus may comprise a decoder (e.g. a Viterbi decoder), configured to decode the soft demodulation, e.g. so as to determine a decoded digital message. The decoder may be configured to output the decoded digital message to a memory or to a processor or other apparatus.

The radio apparatus may be, or may comprise, an integrated circuit such as a system on chip (SoC). The radio apparatus may comprise a processor and a memory. The processor may be configured to execute instructions stored in the memory, e.g. to process data determined using the soft demodulator.

Each of the quadrature demodulator and the soft demodulator may be implemented in hardware (e.g. without a programmable processor), or by software executing on one or more processors, or by a combination of hardware and software. In some embodiments, the radio apparatus comprises receiver circuitry and the receiver circuitry comprises the quadrature demodulator and/or the soft demodulator. The receiver circuitry may comprise a digital logic circuit configured to: apply the first rotation to the first position <x, y>; and/or determine the absolute value of x′ or y′; and/or determine the soft demodulation of the symbol.

In other embodiments, a processor may be configured to execute instructions stored on a memory to: apply the first rotation to the first position <x, y>; and/or determine the absolute value of x′ or y′; and/or determine the soft demodulation of the symbol.

In some embodiments, determining the soft demodulation of the symbol comprises comparing the absolute value of x′ and the absolute value of y′. The smaller of the absolute value of x′ and the absolute value of y′ is the distance of the second position <x′, y′> to the nearest adjacent quadrant. Thus, a comparison of the absolute value of x′ and y′ may be used to determine a distance of the second position <x′, y′> to the nearest adjacent quadrant.

The soft demodulator may be configured to determine a sign of x′ or y′. For instance, the soft demodulator may be configured to determine that x′ is positive if the second position <x′, y′> is to the right of the Y-axis, and negative if the second position <x′, y′> is to the left of the Y-axis. Similarly, the soft demodulator may be configured to determine that y′ is positive if the second position <x′, y′> is above the X-axis, and negative if the second position <x′, y′> is to below the X-axis.

The sign of x′ is indicative of whether the second position <x′, y′> is to the left or right side of the constellation diagram's Y-axis. The sign of y′ is indicative of whether the second position <x′, y′> is above or below the constellation diagram's X-axis. In combination, the sign of x′ and the sign of y′ are indicative of which quadrant of the constellation diagram the second position <x′, y′> is in. For certain layouts of constellation points, any one or more of the following may be used to determine the sign of one or more of the bits of the soft demodulation: i) whether the second position <x′, y′> is to the left or right side of the constellation diagram's Y-axis; ii) whether the second position <x′, y′> is above or below the constellation diagram's X-axis; and iii) a quadrant of the constellation diagram that the second position <x′, y′> is in.

In some embodiments, determining the soft demodulation of the symbol comprises determining a sign of the one of the three soft bits based on the comparison of the absolute value of x′ and the absolute value of y′ (i.e. in dependence upon a result of the comparing of the absolute values of x′ and y′). For instance, when the absolute value of y′ is greater than (e.g. greater than or equal to) the absolute value of x′, the soft demodulator may be configured to use the determined signs of x′ and y′ to set the sign of the one of the three soft bits equal to the sign of y′ multiplied by the inverted sign of x′. When the absolute value of y′ is less than (e.g. less than or equal to) the absolute value of x′, the soft demodulator may be configured to use the determined signs of x′ and y′ to set the sign of the one of the three soft bits equal to the sign of x′ multiplied by the inverted sign of y′.

When a symbol is demodulated as described herein, both the absolute value and the sign of the one of the three soft bits may be determined without searching for a nearest constellation point (e.g. the nearest of the constellation points or rotated constellation points) to either, or both, of the first position <x, y> and the second position <x′, y′>. In some embodiments, both the absolute value and the sign of the one of the three soft bits is determined without determining a distance between any constellation points (e.g. the nearest of the constellation points or rotated constellation points) and either, or both, of the first position <x, y> and the second position <x′, y′>.

In some embodiments, setting the absolute value of the one of the three soft bits is based on the comparison of the absolute value of x′ and the absolute value of y′ (i.e. in dependence upon a result of the comparing of the absolute values of x′ and y′). For instance, the soft demodulator may be configured, when the absolute value of y′ is less than (e.g. less than or equal to) the absolute value of x′, to use the determined absolute value of y′ to set the absolute value of the one of the three soft bits equal to the absolute value of y′. The soft demodulator may be configured, when the absolute value of x′ is less than (e.g. less than or equal to) the absolute value of y′, to use the determined absolute value of x′ to set the absolute value of the one of the three soft bits equal to the absolute value of x′.

In some embodiments, determining the soft demodulation of the symbol comprises using the determined sign of x′ or y′ to set the sign of the one of the three soft bits equal to the sign of x′ or y′. This can provide a particularly efficient approach for setting the sign of the one of the soft bits. For instance, the soft demodulator may be configured to use the determined sign of y′ to set the sign of the one of the three soft bits equal to the sign of y′. The soft demodulator may be configured to use the determined sign of x′ to set the sign of the one of the three soft bits equal to the sign of x′.

In some embodiments, determining the soft demodulation of the symbol comprises using the determined absolute value of x′ to set the absolute value of the one of the three soft bits equal to the absolute value of x′, and using the determined sign of x′ to set the sign of the one of the three soft bits equal to the sign of x′. Setting the (e.g. sign and absolute value of) the one of the soft bits to x′ or y′ can improve the efficiency of determining both the sign and the absolute value of the one of the soft bits.

In some embodiments, determining the soft demodulation of the symbol comprises using the determined absolute value of y′ to set the absolute value of the one of the three soft bits equal to the absolute value of y′, and using the determined sign of y′ to set the sign of the one of the three soft bits equal to the sign of y′.

Either or both of the other two soft bits of the soft demodulation may, in some embodiments, be demodulated using any suitable known technique. In some embodiments, one or two of the soft bits of the soft demodulation are determined using a method disclosed herein whilst the remaining one or two soft bits of the soft demodulation are determined using some other method. However, in other embodiments, all three soft bits are demodulated as disclosed herein.

In some embodiments, determining the soft demodulation of the symbol comprises using the determined absolute value of x′ to set the absolute value of the one of the three soft bits equal to the absolute value of x′, and using the determined absolute value of y′ to set an absolute value of an other of the three soft bits equal to the absolute value of y′. Thus, it will be appreciated that embodiments of the present disclosure provide improved efficiency of determination of the absolute value of two or more bits of the soft demodulation of the received symbol.

In some embodiments, determining the soft demodulation of the symbol comprises using the determined absolute value of y′ to set the absolute value of the one of the three soft bits equal to the absolute value of y′, and using the determined absolute value of x′ to set the absolute value of the other of the three soft bits equal to the absolute value of x′.

In some embodiments, determining the soft demodulation of the symbol comprises using the determined sign of x′ to set the sign of the one of the three soft bits equal to the sign of x′; and using the determined sign of y′ to set the sign of the other of the three soft bits equal to the sign of y′.

In some embodiments, determining the soft demodulation of the symbol comprises using the determined sign of y′ to set the sign of the one of the three soft bits equal to the sign of y′; and using the determined sign of x′ to set the sign of the other of the three soft bits equal to the sign of x′.

In some embodiments, the soft demodulator is configured to apply a second rotation to the first position about the origin of the constellation diagram to determine a third position <x″, y″> on the constellation diagram, wherein the third position <x″, y″> is rotated relative to the X-axis and the Y-axis.

In some embodiments, the soft demodulator is configured to determine an absolute value of x″ or y″.

In some embodiments, determining the soft demodulation of the symbol comprises using the determined absolute value of x″ or y″ to set an absolute value of a further of the three soft bits equal to the absolute value of x″ or y″. Thus it will be seen that, in certain embodiments, an improvement of the efficiency of demodulation of a further bit of the soft demodulation can be achieved by applying a second rotation to the first position <x, y> and using the absolute value of one of the X, Y coordinates of the third position <x″, y″> as the absolute value of the further of the three-bits of the soft demodulation of the symbol. Hence, two or more (e.g. all three) bits of the soft demodulation of the received symbol can be determined efficiently.

In some embodiments, the soft demodulation of the symbol may be determined without searching for a nearest constellation point (e.g. the nearest of the constellation points or rotated constellation points) to one or more, e.g. all, of the first position <x, y>, the second position <x′, y′> and the third position <x″, y″>. This can allow for particularly efficient demodulation, while nevertheless generating soft bits that are similar to those that would be determined if using a Log maximum a posteriori approach.

In some embodiments, the soft demodulation of the symbol may be determined without determining a distance between any constellation points (e.g. any of the constellation points or rotated constellation points) and one or more, e.g. all, of the first position <x, y>, the second position <x′, y′> and the third position <x″, y″>. This can help to provide a particularly efficient approach for soft demodulation of the received symbol.

In some embodiments, the soft demodulator may be configured to determine a sign of x″ or y″.

In some embodiments, determining the soft demodulation of the symbol comprises comparing the absolute value of x″ and the absolute value of y″.

In some embodiments, determining the soft demodulation of the symbol comprises determining a sign of the further of the three soft bits based on the comparison of the absolute value of x″ and the absolute value of y″ (i.e. in dependence upon a result of the comparing of the absolute values of x″ and y″). For instance, when the absolute value of y″ is greater than (e.g. greater than or equal to) the absolute value of x″, the soft demodulator may be configured to use the determined signs of x″ and y″ to set the sign of the one of the three soft bits equal to the sign of y″ multiplied by the inverted sign of x″. When the absolute value of y″ is less than (e.g. less than or equal to) the absolute value of x″, the soft demodulator may be configured to use the determined signs of x″ and y″ to set the sign of the one of the three soft bits equal to the sign of x″ multiplied by the inverted sign of y″.

In some embodiments, setting the absolute value of the one of the three soft bits is based on the comparison of the absolute value of x″ and the absolute value of y″. For instance, when the absolute value of y″ is less than (e.g. less than or equal to) the absolute value of x″, the soft demodulator may be configured to use the determined absolute value of y″ to set the absolute value of the one of the three soft bits equal to the absolute value of y″. When the absolute value of x″ is less than (e.g. less than or equal to) the absolute value of y″, the soft demodulator may be configured to use the determined absolute value of x″ to set the absolute value of the one of the three soft bits equal to the absolute value of x″.

Each of the eight constellation points may correspond to a different respective three-bit symbol value. The term “constellation point” as used herein may refer, depending on the context. to the position of the point on the constellation diagram and/or to the associated three-bit value of the point.

In some embodiments, the three-bit symbol values of adjacent constellation points may have two bits in common. This may reduce the risk of two-bit or three-bit demodulation and/or decoding errors.

The eight constellation points may be equally distributed about a circle centred on the origin. Two of the eight constellation points may lie on an X-axis and a further two of the eight constellation points lie on a Y-axis.

In some embodiments, the first rotation and the eight constellation points are such that if the eight constellation points were rotated by the first rotation, relative to the X-axis and Y-axis, to provide a first set of rotated constellation points, two of the first set of rotated constellation points would be in each quadrant of the constellation diagram. If the first rotation would rotate respective pairs of the eight constellation points into respective quadrants, then to which side of the X-axis the second position <x′, y′> is, and/or to which side of the Y-axis the second position <x′, y′> is, and/or in which quadrant the second position <x′, y′> is, may determine the sign of one or more of the bits of the soft demodulation.

In some embodiments, the first rotation and the eight constellation points are such that four of the first set of rotated constellation points on one side of the X-axis of the constellation diagram correspond to a zero bit in the position of the one of the three soft bits; and a further four of the first set of rotated constellation on the other side of the X-axis of the constellation diagram correspond to a one bit in the position of the one of the three soft bits. Thus, the sign and/or the absolute value of y′ may provide an indication of the bit-value of the transmitted symbol.

In some embodiments, the first rotation and the eight constellation points are such that four of the first set of rotated constellation points on one side of the Y-axis of the constellation diagram correspond to a zero bit in the position of the one of the three soft bits; and a further four of the first set of rotated constellation points on the other side of the Y-axis of the constellation diagram correspond to a one bit in the position the one of the three soft bits.

In some embodiments, the first rotation and the eight constellation points are such that four of the first set of rotated constellation points on one side of the Y-axis of the constellation diagram correspond to a zero bit in the position of an other of the three soft bits; and a further four of the first set of rotated constellation points on the other side of the Y-axis of the constellation diagram correspond to a one bit in the position of the other of the three soft bits. Thus, the sign and/or the absolute value of x′ may provide an indication of the bit-value of the transmitted symbol.

In some embodiments, the first rotation and the eight constellation points are such that four of the first set of rotated constellation points in a first pair of opposing quadrants correspond to a zero bit in the position of the one of the three soft bits, and a further four of the first set of rotated constellation points in the other pair of opposing quadrants correspond to a one bit in the position of the one of the three soft bits. Thus, the signs of x′ and y′ and/or the absolute values of x′ and y′ may provide an indication of the bit-value of the transmitted symbol.

In some embodiments, the first rotation is a rotation of [n*TT/2+π/8] radians, wherein n is any integer value. In some embodiments, the first rotation is a rotation of π/8 radians. In some embodiments, the first rotation is a rotation of minus π/8 radians.

In some embodiments, the second rotation and the eight constellation points are such that if the eight constellation points are rotated by the second rotation to provide a second set of rotated constellation points, two of the second set of rotated constellation points are in each quadrant of the constellation diagram.

In some embodiments, four of the second set of rotated constellation points in a first pair of opposing quadrants correspond to a zero bit in the position of the further of the three soft bits, and a further four of the second set of rotated constellation points in the other pair of opposing quadrants correspond to a one bit in the position of the further of the three soft bits.

In some embodiments, the second rotation is a rotation of [n*π/2±π/8] radians, wherein n is any integer value. In some embodiments, the second rotation is a rotation of minus π/8 radians.

In some embodiments, the radio apparatus is a Bluetooth low energy (BLE) High-Data-Throughput (HDT) radio apparatus, and the interface is configured to receive a radio-frequency signal that is a BLE HDT radio signal or is an electrical signal derived from a received BLE HDT radio signal.

In some embodiments, the radio apparatus is a Wi-Fi radio apparatus, and the interface is configured to receive a radio-frequency signal that is a radio signal in accordance with an 802.11 radio protocol, or is an electrical signal derived therefrom.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the present disclosure will now be described, by way of example only, with reference to the accompanying drawings, in which:

FIG. 1 is an eight-phase-shift-keying constellation diagram;

FIG. 2 is a schematic diagram of a transmission system embodying the disclosure;

FIG. 3 is a schematic diagram of a radio receiver device of the transmission system of FIG. 2;

FIG. 4 is a flow diagram showing a method, embodying the disclosure, that is carried out by a demodulator of the radio receiver device shown in FIGS. 2 and 3 to determine a soft demodulation of a symbol received by the radio transmitter device;

FIG. 5 is an eight-phase-shift-keying constellation diagram showing a received symbol;

FIG. 6 is an eight-phase-shift-keying constellation diagram showing a first, anticlockwise rotation of the received symbol;

FIG. 7 is another eight-phase-shift-keying constellation diagram showing a second, clockwise rotation of the received symbol; and

FIG. 8 is a graph showing the packet error rate as a function of the signal to noise ratio when decoding a received radio-frequency signal using the method of FIG. 4.

### DETAILED DESCRIPTION OF EMBODIMENTS

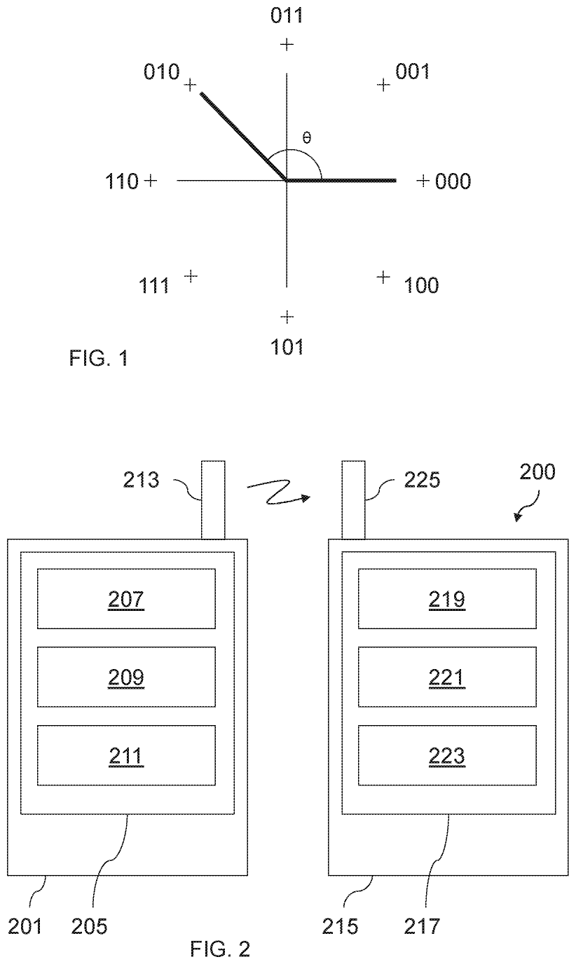

Phase shift keying (PSK) is used to modulate data on one or more carriers in radio protocols such as BLE HDT. One particular type of phase shift keying is eight phase shift keying (8PSK). FIG. 1 shows an 8PSK constellation diagram. As can be seen in the diagram, there are eight constellation points positioned around an origin. The constellation points all lie on a circle with a radius of one, and are evenly spaced at intervals of π/4 radians. Two of the constellation points are positioned on the X-axis and two of the constellation points are positioned on the Y-axis.

Each of these constellation points corresponds to a different three-bit symbol [b₂, b₁, b₀], and the symbols corresponding to each of the constellation points are labelled in FIG. 1. When comparing any two adjacent constellation points, it can be seen that only one of the bits of the adjacent constellation points are different, while the other two are the same.

Each of the 8PSK constellation points can be expressed in polar coordinates as <r, θ>, where r is the distance of the point from the origin and θ is the angle between a line connecting the constellation point to the origin and the X-axis in an anti-clockwise direction.

When using 8PSK to transmit a digital message, a carrier wave is phase-shifted by a phase-shift corresponding to the angle θ of a digital symbol for transmission. For instance, when using the 8PSK constellation diagram shown in FIG. 1 to send a digital message comprising [010], it is necessary to phase shift the signal carrier by 3π/4 radians. A digital message comprising multiple symbols can be transmitted by transmitting the symbols sequentially.

FIG. 2 shows a transmission system 200 which includes a radio transmitter device 201 and a radio receiver device 215. The radio receiver device 215 embodies the present disclosure.

The radio transmitter device 201 includes a system-on-chip (SoC) 205. The SoC 205 comprises radio transmitter circuitry 207, a memory 211 and a microprocessor 209 for executing software stored in the memory 211. The radio transmitter device 201 may also contain other components, such as a battery, crystal oscillator, discrete components, etc., which are omitted from the FIG. 1 for simplicity. The radio transmitter circuitry 207 is connected to a radio antenna 213 for receiving (and, in some embodiments, transmitting) radio signals.

The radio receiver device 215 also has a system-on-chip (SoC) 217, which embodies the present disclosure, comprising radio receiver circuitry 219, a hard decoder 221, and a microcontroller 223 for executing software stored in a memory of the microcontroller. The radio receiver circuitry 219 is connected to an antenna 225 for receiving and transmitting radio signals. The receiver device 215 may contain other components (not shown), such as a battery, crystal oscillator, discrete components, further microprocessors, etc.

In use, the radio transmitter device 201 transmits a radio-frequency signal. The radio-frequency signal is used to send a digital message from the radio transmitter device 201 to the radio receiver device 215. The digital message is transmitted by transmitting a sequence of one or more symbols, each of which are representative of three-bit digital inputs [b₂, b₁, b₀].

The transmitter circuitry 207 is configured to phase-shift a radio-frequency carrier wave by a phase-shift that corresponds to the angle θ of a symbol for transmission on the 8PSK constellation diagram shown in FIG. 1. For example, the transmitter circuitry 207 is configured to phase-shift the carrier wave, relative to a reference phase, by 3π/4 radians to send a symbol that is representative of the three-bit digital input [0, 1, 0]. This phase-shifted carrier wave is then transmitted as a radio signal via the antenna 213.

The radio signal sent by the radio transmitter device 201 may comply with some or all parts of a version of the Bluetooth Low Energy (BLE)™ core specification, e.g. BLE High Data Throughput (HDT). Even more specifically, the radio signal sent by the radio transmitter device 201 may comply with the BLE™ HDT core specification for transmitting 4 Mbps, known as BLE™ HDT4. The radio receiver device 215 may be a BLE receiver. It may support the BLE HDT4 specification.

The radio receiver device 215 is configured to receive, demodulate and decode the radio signal sent by the radio transmitter device 201. The radio receiver device 215 may also transmit similar radio signals.

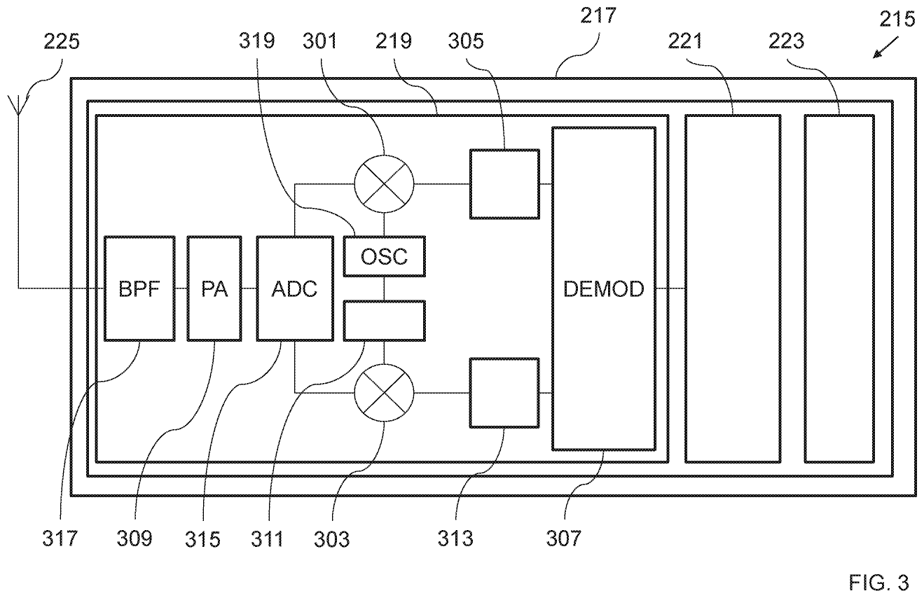

FIG. 3 shows a schematic diagram of the radio receiver device 215. The schematic diagram shows the radio receiver device's antenna 225 and a simplified schematic diagram of the SoC 217. In particular, some of the SoC's receiver circuitry 219 is shown. This includes a band-pass filter 317, a power amplifier 309, an analog-to-digital converter (ADC) 315, an oscillator 319, a phase-shifter 311, a first mixer 301, a second mixer 303, a first matched filter 305, a second matched filter 313 and a soft demodulator 307. The oscillator 319, phase-shift 311, mixers 301, 303, and filters 305, 313 provide a quadrature demodulator, which outputs a pair of values, in each symbol period, to the soft demodulator 307.

The radio receiver device 215, e.g. the SoC 217, may include one or more further components (not shown), such as one or more additional filters, amplifiers or other components for signal processing of the received radio-frequency signal. Operation of the radio receiver device 215 will now be explained with continued reference to FIG. 3.

The antenna 225 is configured to receive the radio signal sent from the radio transmitter device 201, and to provide the radio signal to the band-pass filter 317. The band-pass filter 317 is configured to attenuate frequencies outside of a certain radio-frequency band to help filter out noise. The band-pass filter 317 is configured to provide the filtered radio-frequency signal to the power amplifier 309. The power amplifier 309 is configured to amplify the received radio-frequency signal and to pass the signal to the analog-to-digital converter 315, which converts the radio-frequency signal from an analog signal to a digital signal, which is split and provided to the first mixer 301 and the second mixer 303.

The oscillator 319 is configured to generate a coherent digital signal at the carrier frequency or at an intermediate frequency, and to provide this to both the first mixer 301 and the phase-shifter 311. The phase-shifter 311 is configured to phase-shift the signal provided from the oscillator 319 by a phase shift of π/2 radians, i.e. 90 degrees, and to provide this phase-shifted signal to the second mixer 303. The first mixer 301 is configured to mix the received signal with the output of the oscillator 319, and the second mixer 303 is configured to mix the received signal with the output of the phase-shifter 311. In some embodiments, the signal is mixed to baseband.

The first matched filter 305 is configured to match a sinusoidal waveform to the output of the first mixer 301, and the second matched filter 313 is configured to match a sinusoidal waveform (e.g. the same sinusoidal waveform) to the output of the second mixer 303, in order to determine a real (Y-axis) level and an imaginary (X-axis) level of the received signal, during a symbol period. These IQ values (e.g. a succession of 12-bit samples) may be used to perform gain control, channel synchronization, etc. They are then passed to the demodulator 307. As there is a phase difference of π/2 radians, i.e. 90 degrees, between the outputs of the oscillator 319 and the phase-shifter 311, the inputs to the demodulator 307 are orthogonal, and are representative of a position <x, y> of the symbol received by the radio transmitter device 201 on a phase constellation diagram. The x, y values may be determined within a desired level of precision, e.g. as 7 or 8 bit values.

While a particular approach to quadrature demodulation of the received radio-frequency signal has been described, the focus of this disclosure is on the soft demodulation of the received symbols, for decoding by the hard decoder 221, and it will be appreciated that, in other embodiments, different approaches to quadrature demodulation of the received radio-frequency signal may be used to provide inputs to a soft demodulator that are representative of the position <x, y> of the symbol received by a radio transmitter apparatus.

The position <x, y> of the received radio-frequency signal is unlikely to be exactly the same as the position <r, θ> of the digital input [b₂, b₁, b₀] sent from the radio transmitter device 1 due to various factors such as attenuation of the signal, noise and the like. Thus, some processing of the position <x, y> of the received radio-frequency signal is performed to determine the most likely digital input [b₂, b₁, b₀] modulated onto the carrier signal by the radio transmitter device 1.

The demodulator 307 is configured to carry out soft demodulation of the outputs of the matched filters 305, 313 so as to provide a soft demodulation of the symbol received by the antenna 225. The soft demodulation of the received symbol determines three soft bits [S_{b}_{₂}, S_{b}_{₁}, S_{b}_{₀}], which indicate the likely values of the three bits of the symbol [b₂, b₁, b₀] transmitted by the radio transmitter device 201. The demodulator 307 is configured to provide the soft demodulation of the received symbol [S_{b}_{₂}, S_{b}_{₁}, S_{b}_{₀}] to the hard decoder 221.

A soft bit is a value that is representative of the likely digital value of a bit of data. In this disclosure, a soft-bit value of −1 corresponds to a high confidence that the binary digital value of a bit of data is 0, and a soft-bit value of 1 corresponds to a high confidence that the binary digital value of a bit of data is 1. The value of a soft bit is not constrained to one of these binary values, and in this disclosure the value of the soft bit may be one of a plurality of values between −1 and 1.

The hard decoder 221 is configured to decode the received soft bits so as to recreate the original digital message transmitted by the radio transmitter device 201. In this example the hard decoder 221 includes a Viterbi decoder for decoding the soft bits, although other types of hardware-based or software-based decoder may be used.

The hard decoder 221 may use contextual information, e.g. from a sequence of two or more soft demodulations of received symbols [S_{b}_{₂}, S_{b}_{₁}, S_{b}_{₀}], to determine the original digital message transmitted by the radio transmitter device 201. However, the focus of this disclosure is on the soft demodulation of the received symbols, and so the decoding carried out by the hard decoder 221 will not be discussed in further detail.

One method of generating soft bits [S_{b}_{₂}, S_{b}_{₁}, S_{b}_{₀}] from the position <x, y> of a received symbol is to use the Log Maximum A Posteriori (Max-LogMAP) method. This method is described here by way of contrast with the embodiments of the present disclosure described in more detail below. Equations 1 to 3, below, outline how a three-bit soft demodulation [S_{b}_{₂}, S_{b}_{₁}, S_{b}_{₀}] of a received symbol is calculated from the position <x, y> of the received symbol on an 8PSK constellation diagram, such as the diagram shown in FIG. 1.

$${S}_{{b}_{0} , l} = {b}_{2} {min}_{{b}_{2} , {b}_{1} , {b}_{0} = 0} {\vert z - u ( [ {b}_{2} , {b}_{1} , {b}_{0} ] ) \vert}^{2} - {min}_{{b}_{2} , {b}_{1} , {b}_{0} = 1} {\vert z - u ( [ {b}_{2} , {b}_{1} , {b}_{0} ] ) \vert}^{2} \qquad Equation 1$$

$${S}_{{b}_{1} , l} = {b}_{2} {min}_{{b}_{2} , {b}_{0} , {b}_{1} = 0} {\vert z - u ( [ {b}_{2} , {b}_{1} , {b}_{0} ] ) \vert}^{2} - {min}_{{b}_{2} , {b}_{0} , {b}_{1} = 1} {\vert z - u ( [ {b}_{2} , {b}_{1} , {b}_{0} ] ) \vert}^{2} \qquad Equation 2$$

$${S}_{{b}_{2} , l} = {b}_{2} {min}_{{b}_{0} , {b}_{1} , {b}_{2} = 0} {\vert z - u ( [ {b}_{2} , {b}_{1} , {b}_{0} ] ) \vert}^{2} - {min}_{{b}_{0} , {b}_{1} , {b}_{2} = 1} {\vert z - u ( [ {b}_{2} , {b}_{1} , {b}_{0} ] ) \vert}^{2} \qquad Equation 3$$

In these equations, the soft demodulation has a value of [S_{b}_{₂}, S_{b}_{₁}, S_{b}_{₀}]. The symbol z is used to represent the position <x, y> of the received symbol on the 8PSK constellation diagram shown in FIG. 1, and u([b₂, b₁, b₀]) is used to represent the position of the eight constellation points shown in FIG. 1. For instance, u([0, 1, 0]) represents the position of the constellation point corresponding to [0, 1, 0] shown in FIG. 1. Thus, |z−u([b₂, b₁, b₀])|² is the square of the distance between the position <x, y> of the received symbol and the position of one of the eight constellation points. By way of example, |z−u([0, 1, 0])|² is the square of the distance between the position of the received symbol and the position of the constellation point for a [0, 1, 0].

Hence, this method includes calculating the square of the distance between the position <x, y> of the received symbol and the positions of each of the constellation points. The method also includes for each of the three bits [b₂, b₁, b₀], determining the closest of the constellation points with a bit-value of 1 and the closest of the constellation points with a bit-value of 0. In other words, a search is performed over the constellation points, that includes calculation of the distance between the position <x, y> of the received symbol and each constellation point, to determine which of the constellation points is closest.

Next, for each of the three bits [b₂, b₁, b₀], the square of the distance between the position <x, y> of the received symbol and the position of the closest constellation point with a bit-value of 1 is compared with the square of the distance between the position <x, y> of the received symbol and the position of the closest constellation point with a bit-value of 0. A soft-bit value is determined for each of the three-bits of the soft-bit output [S_{b}_{₂}, S_{b}_{₁}, S_{b}_{₀}] based on (i.e. in dependence upon) these comparisons.

However, the demodulator 307 of the radio receiver device 215 shown in FIGS. 2 and 3 is configured to carry out a more efficient method (embodying the present disclosure) to determine the soft demodulation [S_{b}_{₂}, S_{b}_{₁}, S_{b}_{₀}] of the received symbol than the Max-LogMAP method. In particular, the method carried out by the demodulator 307 does not require a distance between the position <x, y> of the received symbol and the position of any of the constellation points to be calculated, let alone the distance between the position <x, y> of the received symbol and each of the constellation points. Improvements in the efficiency of the demodulator 307 may improve the speed of demodulation, increase battery life and/or facilitate a size and/or cost reduction of the radio receiver device 215.

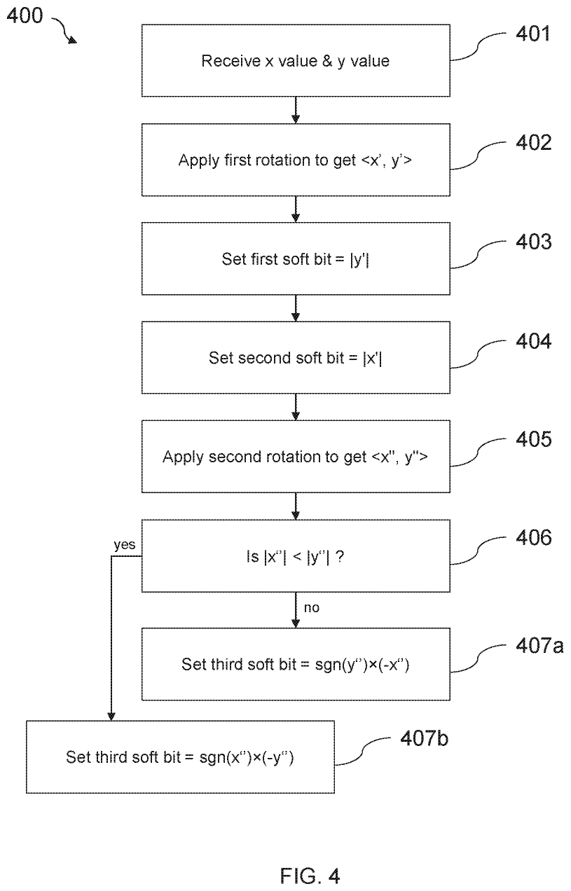

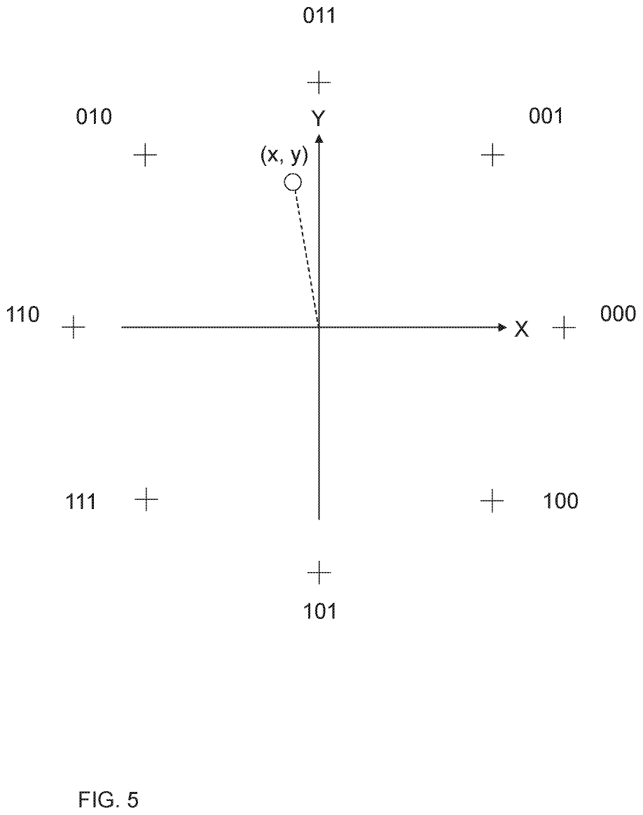

FIG. 4 shows a method 400, embodying the present disclosure, that is carried out by the soft demodulator 307 to determine a soft demodulation [S_{b}_{₂}, S_{b}_{₁}, S_{b}_{₀}] of the symbol received by the radio transmitter device 201. This demodulation may approximate the log-max demodulation sufficiently accurately to allow for reliable decoding (e.g. using a Viterbi decoder), while being more computationally efficient. In particular, it does not require searching over a set of constellation points. This method 400 will now be described in with reference to FIGS. 4, 5, 6 and 7.

A first step 401 of the method 400 includes receiving an X value and a Y value representative of a first position <x, y> of a received symbol on an 8PSK constellation diagram. An exemplary such point is shown in FIG. 4. As will be apparent from the preceding description, this first position <x, y> is based on the outputs of the first and second matched filters 305, 313 which provide a quadrature demodulation of the received eight-phase-shift-key-modulated radio-frequency signal to the demodulator 307.

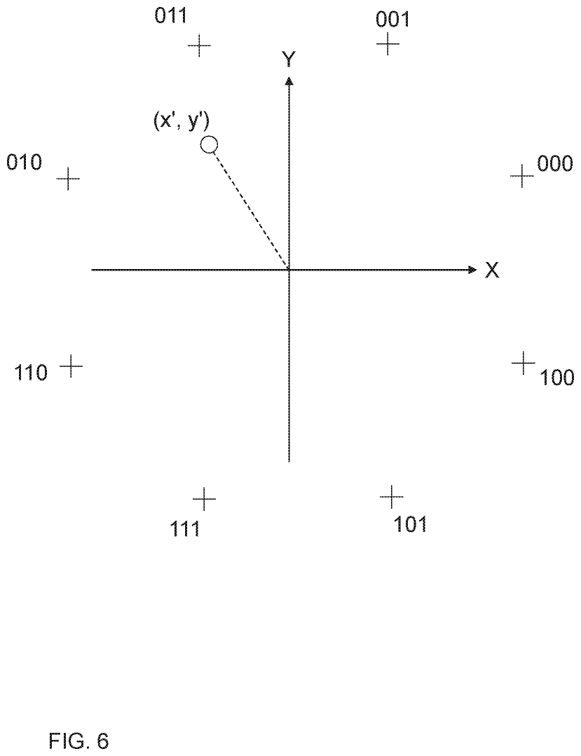

A second step 402 of the method 400 includes applying a first rotation to the first position <x, y> to provide a second position <x′, y′> on the constellation diagram. The first rotation used in this example is an anti-clockwise rotation of π/8 radians, which is shown in FIG. 6.

Although the only calculation performed by the receiver in this step is a rotation of the coordinates of the received symbol relative to the X-axis and Y-axis, this can be seen as, in effect, also rotating the eight constellation points relative to the X-axis and Y-axis. As can be seen in FIG. 6, this rotation would position all of the constellation points with a first bit b₂ having a bit-value of 0 above the X-axis, and all of the constellation points with a first bit b₂ having a bit-value of 1 below the X-axis. It can also be seen that this rotation would position all of the constellation points with a second bit b₁ having a bit-value of 0 to the right of the Y-axis, and all of the constellation points with a second bit b₁ having a bit-value of 1 to the left of the Y-axis.

Thus, it will be appreciated that the Y coordinate y′ of the second position <x′, y′> provides an indication of whether the first bit b₂ of the symbol transmitted by the radio transmitter device 201 is likely to have a bit-value of 1 or 0. Similarly, the X coordinate x′ of the second position <x′, y′> provides an indication of whether the second bit b₁ of the symbol transmitted by the radio transmitter device 201 is likely to have a bit-value of 1 or 0.

As the distance of the second position <x′, y′> from the Y-axis increases, so does the confidence of the bit-value of the first bit b₂ of the symbol transmitted by the radio transmitter device 201. Similarly, as the distance of the second position <x′, y′> from the Y-axis increases, so does the confidence of the bit-value of the symbol transmitted by the radio transmitter device 201.

A third step 403 of the method 400 includes determining the first bit S_{b}_{₂} of the soft demodulation [S_{b}_{₂}, S_{b}_{₁}, S_{b}_{₀}] of the received symbol. In this step 403, the value of y′ is used as the value of the first bit S_{b}_{₂} of the soft demodulation [S_{b}_{₂}, S_{b}_{₁}, S_{b}_{₀}].

A fourth step 404 of the method 400 includes determining the second bit S_{b}_{₁} of the soft demodulation [S_{b}_{₂}, S_{b}_{₁}, S_{b}_{₀}] of the received symbol. In this step 404, the value of x′ is used as the value of the second bit S_{b}_{₁} of the soft demodulation [S_{b}_{₂}, S_{b}_{₁}, S_{b}_{₀}].

Thus, the first two bits S_{b}_{₁}, S_{b}_{₂} of the soft-bit output [S_{b}_{₂}, S_{b}_{₁}, S_{b}_{₀}] can be determined by applying a rotation to the first position <x, y> instead of using equations 1 and 2 of the Max-LogMAP method. Unlike the Max-LogMAP method, this approach does not require computation of the distances between the position <x, y> of the received symbol and each of the constellation points. Additionally, this approach does not require a determination of the closest constellation point with a first bit having a bit-value b₂ of 1 and 0 or a determination of the closest constellation point with a second bit having a bit-value b₁ of 1 and 0. This approach also does not require a comparison of the distances between the position <x, y> of the received symbol and the constellation points. Thus, it will be appreciated that the method 400 shown in FIG. 4 is more efficient that the Max-LogMAP method.

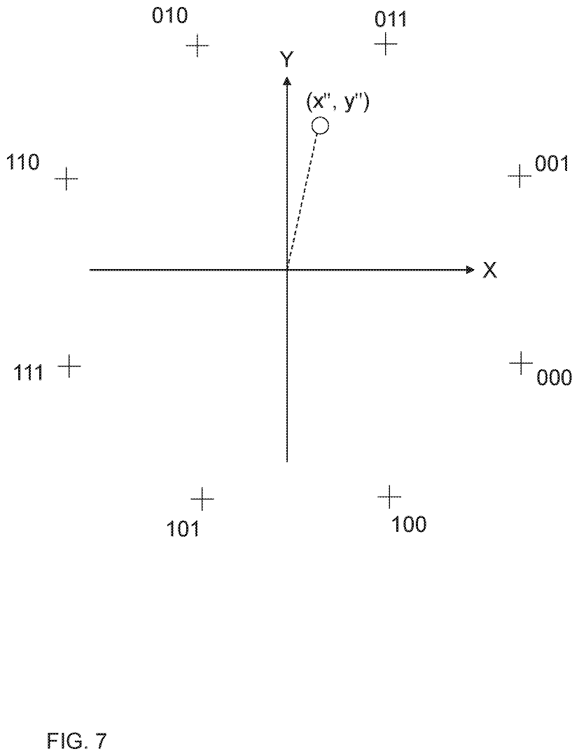

Determination of the third bit S_{b}_{₀} of the soft demodulation [S_{b}_{₂}, S_{b}_{₁}, S_{b}_{₀}] may also be necessary. Thus, a fifth step 405 of the method is to apply a second rotation to the first position <x, y> about the origin of the constellation diagram to provide a third position <x″, y″>. The second rotation used in this example is a clockwise rotation of π/8 radians, which is shown in FIG. 7.

Equation 4, below, shows how the coordinates of the second position <x′, y′> can be calculated. Equation 5 shows how the coordinates of the third position <x″, y″> can be calculated. While the coordinates of the third position <x″, y″> could be calculated independently of the second position <x′, y′>, a more efficient approach is possible based on the fact that the first and second rotations are such that equations 4 and 5 include the common items

$$( cos \frac{π}{8} + j sin \frac{π}{8} ) and ( sin \frac{π}{8} - j cos \frac{π}{8} ) .$$

Thus, the method 400 may calculate these two expressions only once in order to determine both the second and third positions. This is more computationally efficient than calculating the two positions separately.

$${x}^{′} + j {y}^{′} = ( x + jy ) ( cos \frac{π}{8} + j sin \frac{π}{8} ) = x ( cos \frac{π}{8} + j sin \frac{π}{8} ) - y ( sin \frac{π}{8} - j cos \frac{π}{8} ) \qquad Equation 4$$

$${x}^{″} + j {y}^{″} = ( x + jy ) ( cos \frac{π}{8} + j sin \frac{π}{8} ) = x ( cos \frac{π}{8} + j sin \frac{π}{8} ) - y ( sin \frac{π}{8} - j cos \frac{π}{8} ) \qquad Equation 5$$

As can be seen in FIG. 7, a clockwise rotation of π/8 radians would positions all of the constellation points with a third bit b₀ having a bit-value of 1 in the top right and bottom left quadrants of the constellation diagram. It can also be seen that this rotation would position all of the constellation points with a third bit b₀ having a bit-value of 0 in the top left and bottom right quadrants of the constellation diagram.

Thus, it will be appreciated that the quadrant of the third position <x″, y″> provides an indication of whether the third bit b₀ of the transmitted symbol is likely to have a bit-value of 1 or 0. In particular, a combination of the quadrant of the third position <x″, y″> and a distance of the third position <x″, y″> from the nearest adjacent quadrant provides an indication of the likelihood that third bit b₀ of the transmitted symbol has a bit-value of 1 or 0.

In each of the four quadrants, it is possible to determine the nearest adjacent quadrant by comparing the absolute value of y″ with the absolute value of x″. For instance, for a position <x″, y″> in the top right quadrant, the nearest adjacent quadrant is the top left quadrant if the absolute value of y″ is greater than the absolute value of x″. However, if the absolute value of x″ is greater than the absolute value of y″, the nearest adjacent quadrant would be the bottom right quadrant.

The distance between the third position <x″, y″> and the nearest adjacent quadrant is either the absolute value of x″ or the absolute value of y″. For instance, in the top right quadrant, the distance between the third position and the nearest adjacent quadrant is x″ if the absolute value of x″ is greater than the absolute value of y″. However, the distance between the third position <x″, y″> and the nearest adjacent quadrant is y″ if the absolute value of x″ is greater than the absolute value of y″. The same logic can be applied to any of the four quadrants.

Hence, the method 400 includes a sixth step 406 which is to compare the absolute value of the X coordinate of the third position <x″, y″> with the absolute value of the Y coordinate of the third position <x″, y″>. The method also includes conditional seventh step 407a or 407b which determines the sign and the absolute value of the soft bit Sbo, based on the comparison, using equations 6 and 7, below.

In equations 6 and 7, sign(y″) is a function that outputs a positive sign or a negative sign based on the sign of the Y coordinate of the third position <x″, y″>. Similarly, sign (x″) is a function that outputs a positive sign or a negative sign based on the sign of the Y coordinate of the third position <x″, y″>.

If |y″|≥|x″|,S_{b}_{₀}=sign(y″)×(−x″) Equation 6

If |y″|<x″|,S_{b}_{₀}=sign(x″)×(−y″) Equation 7

As can be seen in these equations, the absolute value of the x″ is used as the absolute value of the third bit S_{b}_{₀} of the soft demodulation if this is the distance to the nearest adjacent quadrant. Similarly, the absolute value of the y″ is used as the absolute value of the third bit S_{b}_{₀} of the soft demodulation if this is the distance to the nearest adjacent quadrant. Thus, as the distance of the third position <x″, y″> from the nearest adjacent quadrant increases, so does the confidence that the third bit b₀ of the transmitted symbol has a certain bit-value.

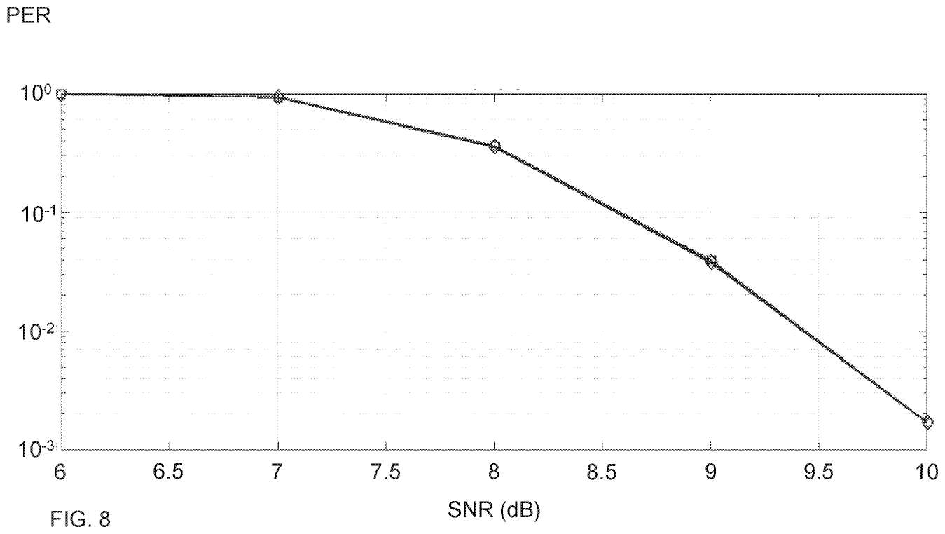

FIG. 8 is a graph showing simulated packet error rate (PER) as a function of the signal to noise ratio (SNR) when decoding a BLE HDT4 packet with a 128-byte payload. The packet error rate is shown for a simulation using an implementation of the method 400 shown in FIG. 4 and also for a simulation using a conventional Max-LogMAP method. The two results lines are so closely aligned as to be indistinguishable from one another in FIG. 8, indicating that the packet error rates using each of these approaches are very similar.

However, the method 400 of FIG. 4 is more efficient than the Max-LogMAP method, and so various advantages may be achieved by using the method 400 of FIG. 4 rather than the Max-LogMAP method.

It will be appreciated by those skilled in the art that the invention has been illustrated by describing one or more specific embodiments thereof, but is not limited to these embodiments; many variations and modifications are possible, within the spirit and scope of the disclosure.

1. A radio apparatus configured to demodulate an eight-phase-shift-key-modulated radio-frequency signal, wherein the radio apparatus comprises:
an interface, configured to receive an eight-phase-shift-key-modulated radio-frequency signal;
a quadrature demodulator, configured to quadrature demodulate the radio-frequency signal to determine, for a symbol of the radio-frequency signal, a first position <x, y> on a predetermined constellation diagram, wherein the predetermined constellation diagram comprises an X-axis, a Y-axis, and eight constellation points; and
a soft demodulator, configured to:
apply a first rotation to the first position <x, y> about an origin of the constellation diagram to determine a second position <x′, y′> on the constellation diagram, wherein the second position <x′, y′> is rotated relative to the X-axis and the Y-axis;
determine an absolute value of x′ and an absolute value of y′; and
determine a soft demodulation of the symbol, wherein the soft demodulation comprises three soft bits, and wherein the determining the soft demodulation comprises comparing the determined absolute value of x′ and the determined absolute value of y′, and setting an absolute value of one of the three soft bits equal to the absolute value of x′ or y′ based on the comparing.

2. The radio apparatus as claimed in claim 1, wherein determining the soft demodulation of the symbol further comprises determining a sign of the one of the three soft bits based on the comparing.

3. The radio apparatus as claimed in claim 1, wherein:
the soft demodulator is configured to determine a sign of x′ or y′; and
determining the soft demodulation of the symbol comprises using the determined sign of x′ or y′ to set the sign of the one of the three soft bits equal to the sign of x′ or y′.

4. The radio apparatus as claimed in claim 3, wherein determining the soft demodulation of the symbol comprises:
using the determined absolute value of x′ to set the absolute value of the one of the three soft bits equal to the absolute value of x′, and using the determined sign of x′ to set the sign of the one of the three soft bits equal to the sign of x′; or
using the determined absolute value of y′ to set the absolute value of the one of the three soft bits equal to the absolute value of y′, and using the determined sign of y′ to set the sign of the one of the three soft bits equal to the sign of y′.

5. The radio apparatus as claimed in claim 1, wherein determining the soft demodulation of the symbol comprises:
using the determined absolute value of x′ to set the absolute value of the one of the three soft bits equal to the absolute value of x′, and using the determined absolute value of y′ to set an absolute value of an other of the three soft bits equal to the absolute value of y′; or
using the determined absolute value of y′ to set the absolute value of the one of the three soft bits equal to the absolute value of y′, and using the determined absolute value of x′ to set the absolute value of the other of the three soft bits equal to the absolute value of x′.

6. The radio apparatus as claimed in claim 1, wherein the soft demodulator is configured to:
apply a second rotation to the first position about the origin of the constellation diagram to determine a third position <x″, y″> on the constellation diagram, wherein the third position <x″, y″> is rotated relative to the X-axis and the Y-axis; and
determine an absolute value of x″ or y″;
wherein determining the soft demodulation of the symbol comprises using the determined absolute value of x″ or y″ to set an absolute value of a further of the three soft bits equal to the absolute value of x″ or y″.

7. The radio apparatus as claimed in claim 6, wherein determining the soft demodulation of the symbol comprises:
comparing the absolute value of x″ and the absolute value of y″; and
determining a sign of the further of the three soft bits based on the comparing.

8. The radio apparatus as claimed in claim 6, wherein determining the soft demodulation of the symbol comprises:
comparing the absolute value of x″ and the absolute value of y″; and
wherein setting the absolute value of the further of the three soft bits is based on the comparing.

9. The radio apparatus as claimed in claim 6, wherein the second rotation is a rotation of [n*π/2±π/8] radians, wherein n is any integer value.

10. The radio apparatus as claimed in claim 9, wherein the second rotation is a rotation of minus π/8 radians.

11. The radio apparatus as claimed in claim 6, wherein the second rotation and the eight constellation points are such that if the eight constellation points are rotated by the second rotation to provide a second set of rotated constellation points:
two of the second set of rotated constellation points are in each quadrant of the constellation diagram;
four of the second set of rotated constellation points in a first pair of opposing quadrants correspond to a zero bit in the position of the further of the three soft bits; and
a further four of the second set of rotated constellation points in the other pair of opposing quadrants correspond to a one bit in the position of the further of the three soft bits.

12. The radio apparatus as claimed in claim 1, wherein the first rotation is a rotation of [n*π/2+π/8] radians, wherein n is any integer value.

13. The radio apparatus as claimed in claim 12, wherein the first rotation is a rotation of minus π/8 radians.

14. The radio apparatus as claimed in claim 12, wherein the first rotation is a rotation of π/8 radians.

15. The radio apparatus as claimed in claim 1, wherein the first rotation and the eight constellation points are such that if the eight constellation points are rotated by the first rotation to provide a first set of rotated constellation points:
two of the first set of rotated constellation points are in each quadrant of the constellation diagram;
four of the first set of rotated constellation points on one side of the X-axis of the constellation diagram correspond to a zero bit in the position of the one of the three soft bits; and
a further four of the first set of rotated constellation points on the other side of the X-axis of the constellation diagram's correspond to a one bit in the position of the one of the three soft bits.

16. The radio apparatus as claimed in claim 1, wherein the first rotation and the eight constellation points are such that if the eight constellation points are rotated by the first rotation to provide a first set of rotated constellation points:
two of the first set of rotated constellation points are in each quadrant of the constellation diagram;
four of the first set of rotated constellation points on one side of the Y-axis of the constellation diagram correspond to a zero bit in the position of an other of the three soft bits; and
a further four of the first set of rotated constellation points on the other side of the Y-axis of the constellation diagram correspond to a one bit in the position of the other of the three soft bits.

17. The radio apparatus as claimed in claim 1, wherein the first rotation and the eight constellation points are such that if the eight constellation points are rotated by the first rotation to provide a first set of rotated constellation points:
two of the first set of rotated constellation points are in each quadrant of the constellation diagram;
four of the first set of rotated constellation points in a first pair of opposing quadrants correspond to a zero bit in the position of the one of the three soft bits; and
a further four of the first set of rotated constellation points in the other pair of opposing quadrants correspond to a one bit in the position of the one of the three soft bits.

18. The radio apparatus as claimed in claim 1, wherein the received eight-phase-shift-key-modulated radio-frequency signal is an electrical signal derived from a received Bluetooth low energy HDT radio signal.

19. A method of demodulating an eight-phase-shift-key-modulated radio-frequency signal, the method comprising:
receiving an eight-phase-shift-key-modulated radio-frequency signal;
quadrature demodulating the radio-frequency signal to determine, for a symbol of the radio-frequency signal, a first position <x, y> on a predetermined constellation diagram, wherein the predetermined constellation diagram comprises an X-axis, a Y-axis, and eight constellation points;
applying a first rotation to the first position <x, y> about an origin of the constellation diagram to determine a second position <x′, y′> on the constellation diagram, wherein the second position <x′, y′> is rotated relative to the X-axis and the Y-axis;
determining an absolute value of x′ and an absolute value of y′; and
determining a soft demodulation of the symbol, wherein the soft demodulation comprises three soft bits, and wherein determining the soft demodulation comprises comparing the determined absolute value of x′ and the determined absolute value of y′, and setting an absolute value of one of the three soft bits equal to the absolute value of x′ or y′ based on the comparing.
